(19) United States
(12) Patent Application Publication
(10) Pub. No.: US 2005/0186547 A1
(43) Pub. Date: Aug. 25, 2005

(54) Learning device with page indicators

(75) Inventors: Kuo-Ping Yang, Taipei (TW); Ching-Hsiang Shih, Taipei (TW); Shu-Hua Guo, Taipei (TW); Yen-Jui Chiao, Taipei (TW); Ming Hsiang Cheng, Taipei (TW); Chao Jen Huang, Taipei (TW); I-Nan Wu, Taipei (TW)

Correspondence Address: BACON & THOMAS, PLLC, 625 SLATERS LANE, FOURTH FLOOR, ALEXANDRIA, VA, 22314, US

(73) Assignee: Kuo-Ping Yang, Taipei (TW)

(21) Appl. No.: 10/840,243

(22) Filed: May 7, 2004

(30) Foreign Application Priority Data
Feb. 20, 2004 (TW) 093104196

(51) Int. Cl. G09B 5/00

(52) U.S. Cl. 434/308

(57) ABSTRACT

A learning device with page indicators includes a case, a touch pad, an electronic control unit and multiple page indicators. When each learning card is placed on the touch pad, the position next to the page actuating mark of each learning card has one corresponding page indicator. When the page actuating mark is touched, the corresponding page indicator is activated.

### BACKGROUND OF THE INVENTION

1. Field of the Invention

The present invention relates to a learning device with page indicators.

2. Description of the Related Art

A learning device with a touch panel typically utilizes different learning cards placed upon the touch panel. A user may use a finger or a pen (such as a stylus or a sensor pen) to press the learning card. Examples of such systems include the very popular Leap Pad™ developed by the company Leap Frog™, or U.S. Pat. Nos. 6,369,721, 5,466,158 and 5,088,928.

Since many different learning cards may be used for the learning device, two primary methods have been developed with regards to the placement of the learning card. The first involves insertion and utilization of a single learning card, as disclosed in U.S. Pat. No. 5,088,928; the second utilizes the paging of a plurality of learning cards, as disclosed in U.S. Pat. Nos. 6,369,721 and 5,466,158. Regardless of the method applied, the user, and especially a young user, may not be able to tell which learning card is currently in use. Taking the Leap Pad™ product of Leap Frog™ as an example, the user must find a “Go” mark on the learning card and then press this “Go” mark. The touch panel of the learning device detects that the “Go” mark has been touched. As each learning card has a different “Go” mark position, the user can differentiate between learning cards by their corresponding “Go” mark positions. However, after the user changes to another learning card, he or she may forget to press the “Go” mark, and so the learning device will continue to operate using the old command set of the previous learning card.

Therefore, it is desirable to provide a learning device with page indicators to mitigate and/or obviate the aforementioned problems.

### SUMMARY OF THE INVENTION

A main objective of the present invention is to enable a user to determine which command set of a learning card a learning device is utilizing. In order to achieve the above-mentioned objective, the present invention includes a case, a touch panel mounted on the case, and an electronic control unit electrically connected to the touch panel.

A characteristic of the present invention is that the learning device includes a plurality of page indicators, such as glowing indictors; and the touch panel includes at least one page indication area. When the page indication area is touched, the electronic control unit activates one of the page indicators according to the touch signal. In a preferred embodiment, the plurality of page indicators are placed next to at least one edge of the touch panel on the case; when the learning cards are placed on the touch panel, the page actuating mark of each learning card is disposed next to a corresponding page indicator. When any page actuating mark is touched, the corresponding page indicator is turned on.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment according to the present invention.

FIG. 2 illustrates a circuit structure of the first embodiment according to the present invention.

FIG. 3 is a flowchart of a process for determining how to activate a page indicator according to the present invention.

FIG. 4 is a front view of the first embodiment according to the present invention, which shows an activated glowing indicator.

FIG. 5 is a front view of the first embodiment according to the present invention, which shows another activated glowing indicator.

FIG. 6 illustrates a positional relationship of a learning card and a page actuating mark.

FIG. 7 illustrates a positional relationship of a learning card and a “command”.

FIG. 8 is a perspective view of a second embodiment according to the present invention.

FIG. 9 is a perspective view of a third embodiment according to the present invention.

FIG. 10 is a perspective view of a fourth embodiment according to the present invention.

### DETAILED DESCRIPTION OF THE PREFERRED EMBODIMENT

Four embodiments of the present invention are introduced in the following to variously explain the present invention.

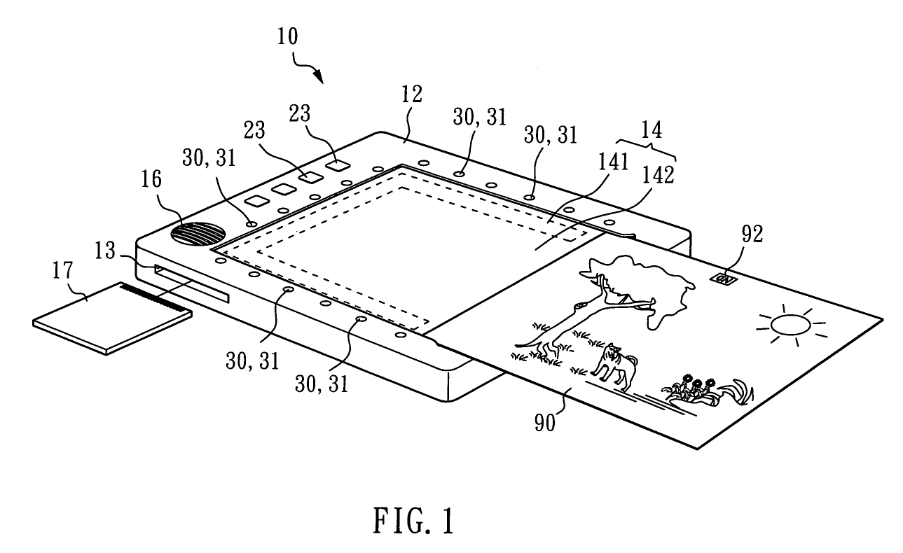

Please refer to FIGS. 1 to 7 for a first embodiment of the present invention. FIG. 1 is a perspective view of a first embodiment of the present invention. A learning device with page indicators 10 comprises a case 12, and the case 12 further comprises a touch panel 14, a slot 13, a plurality of operating buttons 23 and a speaker 16. When a user uses the learning device with page indicators 10, he or she needs to place a learning card 90 on the touch panel 14 and insert a memory card 17 (which stores learning data corresponding to the learning card 90, such as audio data or a software program) into the slot 13. A difference between the present invention 10 and the prior art device is that the case 12 further comprises a plurality of page indicators 30, which are preferably mounted on the edges of the touch panel 14. The page indicators 30 are glowing indictors 31 (such as LEDs). It should be noted that the above phrase “on the edges of the touch panel 14” does not necessary mean all edges of the touch panel 14. As shown in FIG. 1, the plurality of page indicators 30 are mounted on an upper edge, a lower edge and a left edge of the touch panel 14.

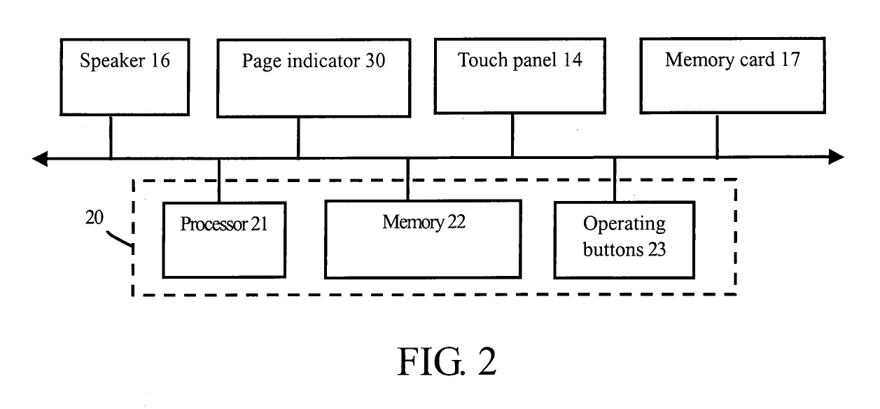

FIG. 2 illustrates a circuit structure of the first embodiment. An electronic control unit 20 includes a processor 21 and a memory 22; the operating buttons 23, the touch panel 14, the speaker 16, the plurality of page indicators 30 and the memory card 17 are all electrically connected to the electronic control unit 20. Since this circuit structure is similar to the general learning device, no further detailed description is required.

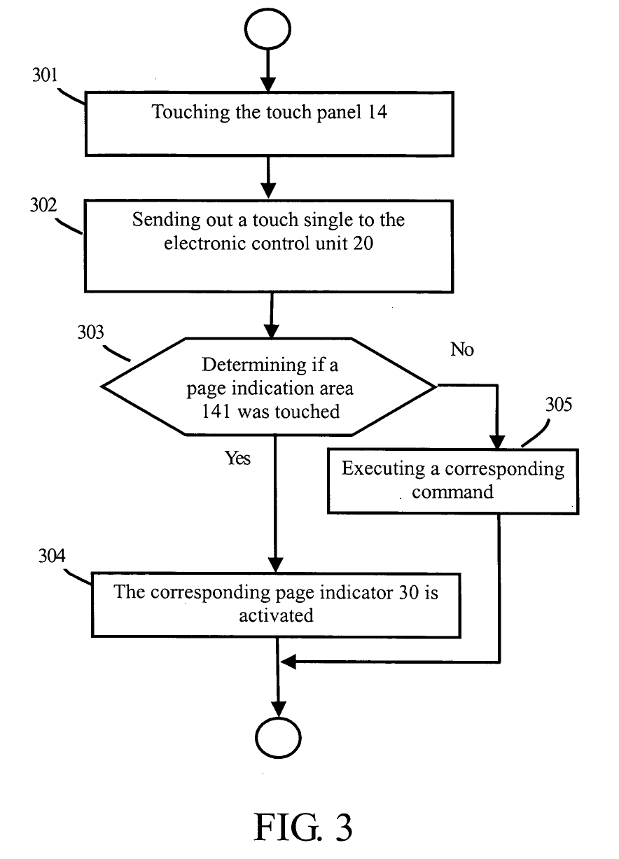

FIG. 3 is a flowchart for determining how to activate a page indicator. Please refer again to FIGS. 1 to 7 for the following description of the page indicators 30.

Step 301:

The user uses a finger or a pen (such as a stylus or a sensor pen) to press the learning card 90, which is on the learning device with page indicators 10, and so touches the touch panel 14 (here “touch” means not simply a pressure-sensitive action, but may also include electrical or magnetic sensing, as used in the Leap Pad™ product).

Step 302:

The touch panel 14 sends out a touch single to the electronic control unit 20. This touch signal provides a position signal so that the electronic control unit 20 knows which region of the touch panel 14 has been touched.

Step 303:

Determine if a page indication area 141 was touched. If it was, perform step 304; otherwise perform step 305.

The touch panel 14 can be divided into the page indication area 141 and a learning area 142. The page indication area 141 is marked with a dashed line in FIG. 1. In this embodiment, the page indication areas 141 are located along three edges of the touch panel 14. Furthermore, there is a page actuating mark 92 with, for example, an “ON” sign on the learning card 90, which is also positioned according to the page indication areas 141.

Step 304:

The corresponding page indicator 30 is activated.

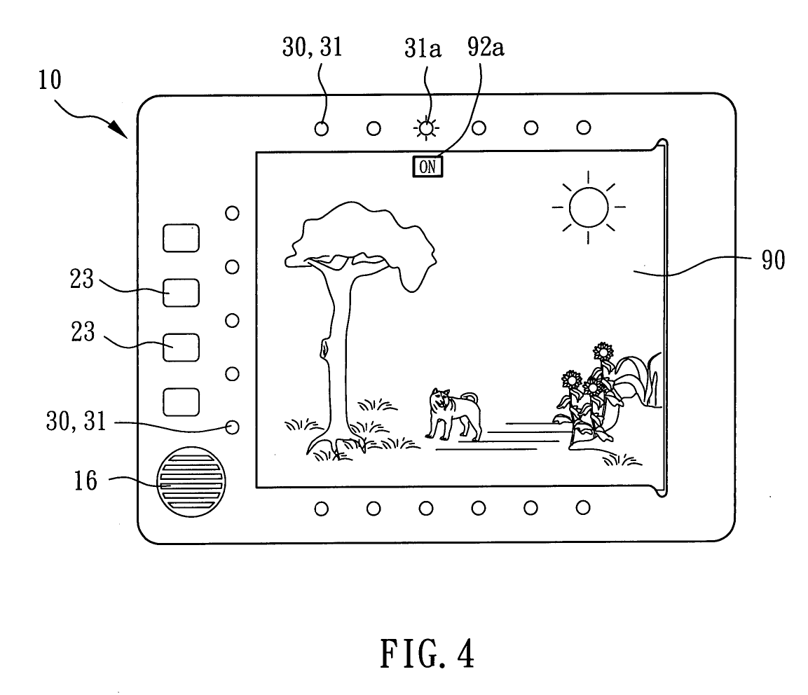

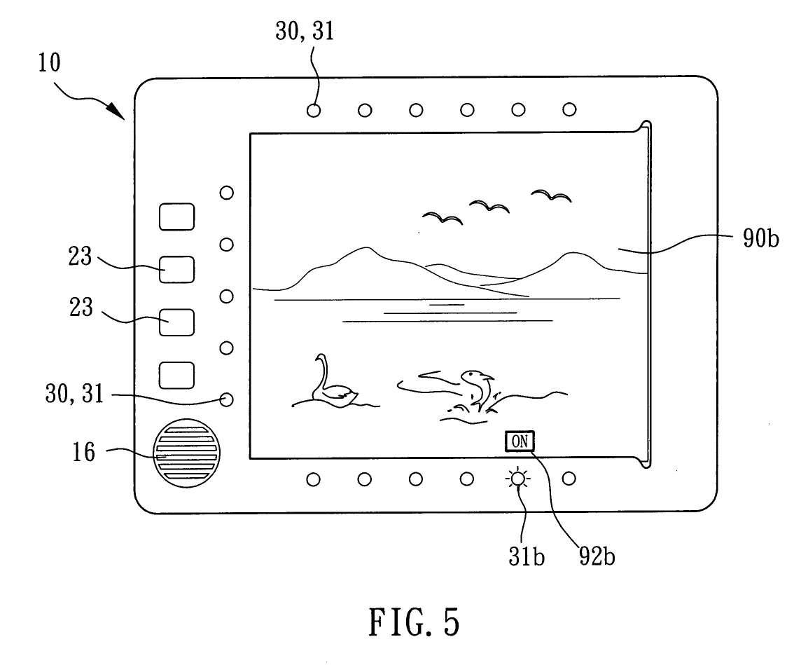

Taking FIG. 4 as an example, the page actuating mark 92a on the learning card 90 has been touched, and so the next page indicator (glowing indicator) 31a is turned on. With reference to FIG. 5, when the user changes to another learning card 90b, he or she presses the page actuating mark 92b, and so the next page indicator (glowing indicator) 31b is turned on. But if the user forgets to press the page actuating mark 92b, the page indicator (glowing indicator) 31a (as shown in FIG. 4) would remain turned on. Since, in this case, the page actuating mark 92b and the page indicator (glowing indicator) 31a do not match, the user will notice this, and so informed, press the page actuating mark 92 to operate the learning card 90b.

Taking the first embodiment as an example, there may be 17 page indicators 30, and therefore, for 17 different learning cards 90, each learning card 90 will have one corresponding page actuating mark 92, all of which are located at different positions and respectively correspond to each page indicator 30. All page actuating marks 92 are also located in the page indication area 141. The page indication area 141 is composed of the page actuating mark 92 of each learning card 90, and the position of the page indication area 141 can be stored in the memory 22 or the memory card 17. Therefore, the page indication area 141 and the learning area 142 on the touch panel 14 are not necessary visibly divided, but are controlled by a program or the electrical control unit 20.

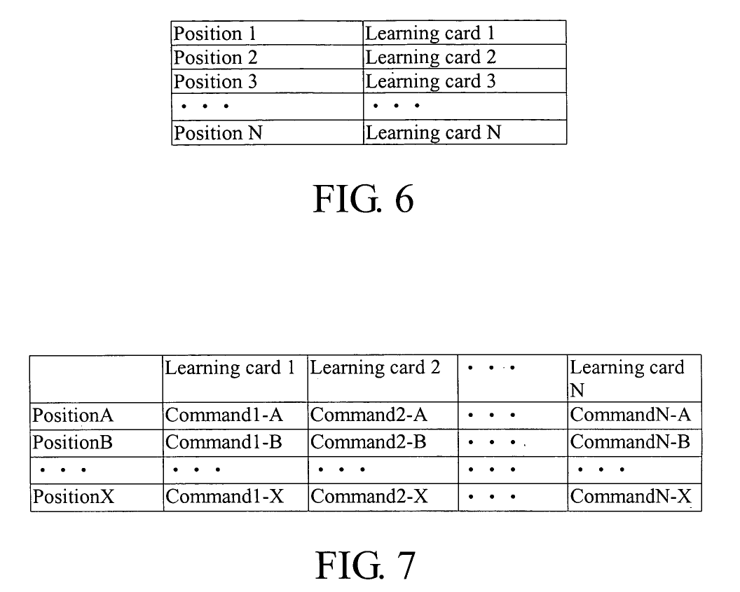

The electrical control unit 20 can not only turn on the corresponding page indicator 30 according to the touched position on the page indication area 141, but can also determine which learning card 90 is being used. Please refer to FIG. 6. FIG. 6 illustrates a positional relationship of a learning card and a page actuating mark. For example, a “Position 2” (which usually refers to a block area) in the page indication area 141 corresponds to a second learning card 90; however, this is well-known technology, and so requires no further detailed explanation.

Step 305:

When a region is touched that is not a page indication area, a corresponding command is performed. Please refer to FIG. 7. FIG. 7 illustrates a positional relationship of a learning card and a “command”. For example, for the second learning card (the corresponding page indicator 30 is turned on), when a “Position B” (which typically refers to a block area) is touched, the electrical control unit 20 executes a “command 2-B” that plays an English vocabulary word “dog” through the speaker 16; however, this is a well-known technology, and so no further detailed explanation is provided.

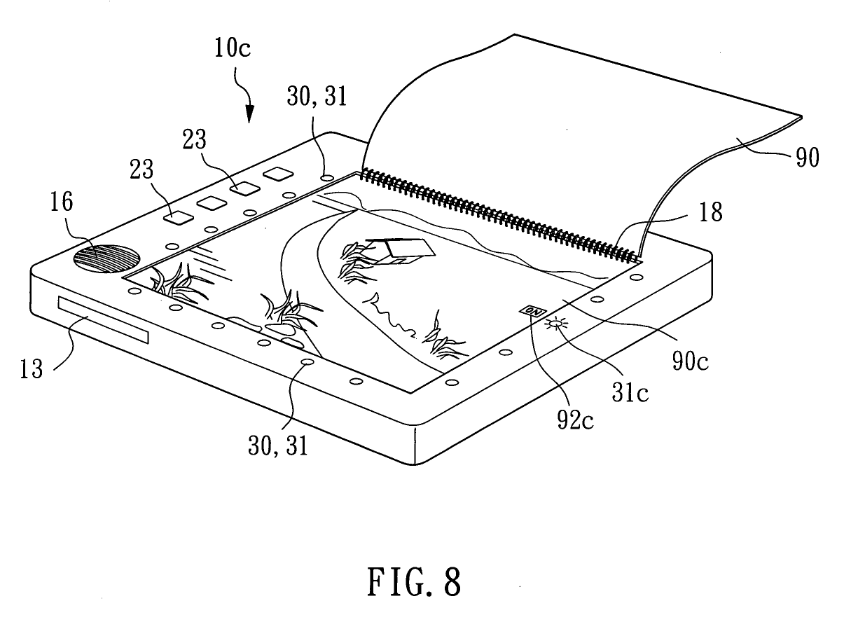

Please refer to FIG. 8. FIG. 8 is a perspective view of a second embodiment 10c according to the present invention. The main difference between this embodiment 10c and the first embodiment 10 is that the learning device 10c further comprises a clip mechanism 18 on the case 12. In this second embodiment, the clip mechanism 18 is located above the touch panel 14. The clip mechanism 18 is used to collect together the plurality of learning cards 90 so that the user may easily page through the learning cards 90 on the touch panel 14. In FIG. 8, there is a page actuating mark 92c on the learning card 90c, and the corresponding glowing indicator 31c is turned on.

Since the clip mechanism 18 is a well-known technology (refer to U.S. Pat. No. 6,369,721), no further detailed explanation is required.

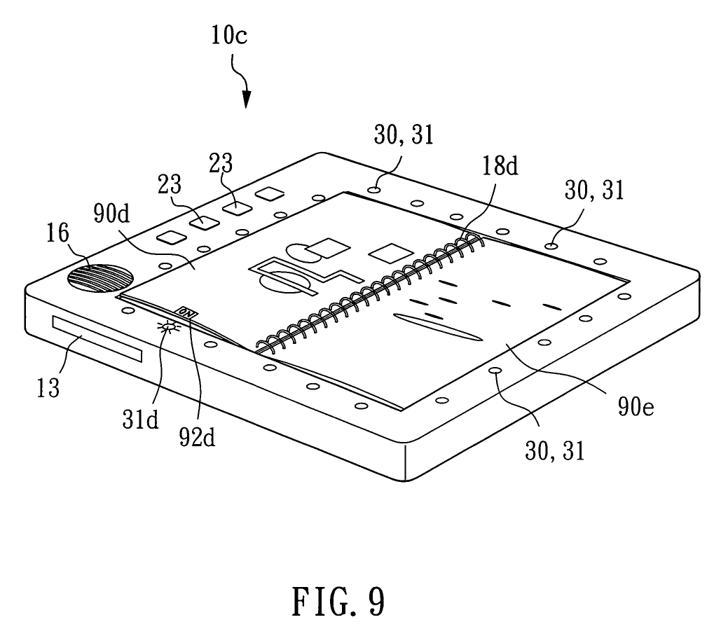

Please refer to FIG. 9. FIG. 9 is a perspective view of a third embodiment according to the present invention. The main difference between this embodiment and the second embodiment is that the clip mechanism 18 is located in the middle of the entire touch panel (which has left and right touch panels, not shown in FIG. 9), and so two learning cards 90d, 90e can be utilized at the same time (this design is similar to the Leap Pad™ product). Therefore, either one of the two learning cards having a page actuating mark is suitable. For example, only the learning card 90d has a page actuating mark 92d, as shown in FIG. 9, and when the page actuating mark 92d is touched, the corresponding glowing indicator 30 is turned on.

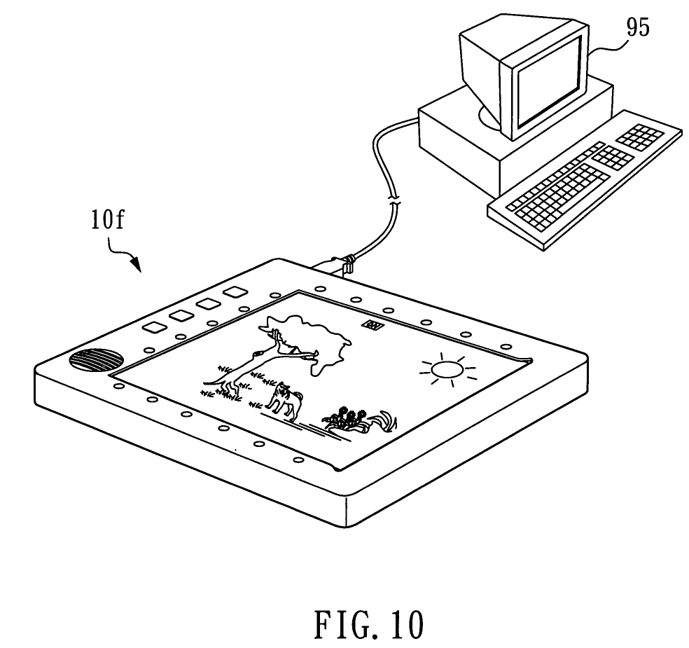

Please refer to FIG. 10. FIG. 10 is a perspective view of a fourth embodiment 10f according to the present invention. The main difference between this embodiment 10f and the first embodiment 10 is that the learning device 10f is connected to an external electrical device 95 (such as a computer, a PDA or a DVD, either through a wired or wireless connection). The learning device 10f can be treated as an input device of the electrical device 95. When the learning device 10f sends a position signal to the electrical device 95, the electrical device 95 executes a corresponding learning program according to the position signal, which is a well-known technology (refer to U.S. Pat. Nos. 6,369,721 and 5,088,928), and so no further detailed explanation is provided.

Although the present invention has been explained in relation to its preferred embodiment, it is to be understood that many other possible modifications and variations can be made without departing from the spirit and scope of the invention as hereinafter claimed.

1. A learning device with page indicators for utilizing a learning card, the learning device comprising:
a case;
a touch panel mounted on the case and the learning card capable of being disposed on the touch panel; and
an electronic control unit electrically connected to the touch panel, the touch panel providing a touching signal to the electronic control unit when touched, and the electronic control unit determining which region of the touch panel is touched according to the touching signal;
the learning device with page indicators further comprising:
a plurality of page indicators mounted on the case and controlled by the electronic control unit; and
the touch panel comprising at least one page indication area, and when the page indication area is touched, the electronic control unit activates a page indicator according to the touching signal.

2. The learning device with page indicators as claimed in claim 1, wherein the page indicator is a glowing indicator, the glowing indicator illuminating when activated.

3. The learning device with page indicators as claimed in claim 1, wherein the plurality of page indicators are disposed next to at least one edge of the touch panel on the case.

4. The learning device with page indicators as claimed in claim 1 further comprising a clip mechanism mounted on the case, the clip mechanism capable of clipping a plurality of learning cards together to enable a user to page through the learning cards.

5. The learning device with page indicators as claimed in claim 1 further comprising a plurality of learning cards, and at least every two learning cards have a page actuating mark.

6. The learning device with page indicators as claimed in claim 5, wherein the page actuating marks are along an edge of the learning card, and when the learning cards are placed on the touch panel, the page actuating marks are placed on the page indication area on the touch panel.

7. The learning device with page indicators as claimed in claim 6, wherein the plurality of page indicators are placed next to at least one edge of the touch panel on the case, and when the learning cards are placed on the touch panel, the page actuating mark of each learning card is next to a corresponding page indicator so when each page actuating mark is touched, the corresponding page indicator is activated.

8. The learning device with page indicators as claimed in claim 1 being attached to an electronic device for use as an input device of the electronic device.
